(19) United States
(12) Patent Application Publication
(10) Pub. No.: US 2008/0199586 A1
(43) Pub. Date: Aug. 21, 2008

(54) Nutritional herb and fruit beverage

(76) Inventor: Brent Barton, Highland, UT (US)

Correspondence Address: THORPE NORTH & WESTERN, LLP., P.O. Box 1219, SANDY, UT, 84091-1219, US

(21) Appl. No.: 11/709,329

(22) Filed: Feb. 20, 2007

(51) Int. Cl. A23L 2/00

(52) U.S. Cl. 426/599

(57) ABSTRACT

Fruit drinks, concentrates, and methods for providing positive health benefits to an individual are disclosed and described. In one embodiment, a fruit-based drink or drink concentrate can comprise longan; a berry selected from the group consisting of lycium berry, hawthorne berry schisandra berry, seabuckthorn berry, and mixtures thereof; and an herb selected from the group consisting of astragalus, jujube date, coriolus versicolor, rhodiola rosea, and mixtures thereof. In another embodiment, the fruit-based drink or concentrate can comprise apple juice; a secondary fruit juice selected from the group consisting of pineapple, white grape, pear, and mixtures thereof; a fruit or herb selected from the group consisting of euphoria longan, lyceum berry, astragalus, jujube date, gac, cili, seabuckthorn berry, coriolus versicolor, durian, and mixtures thereof. Such fruit-based drinks can be used to provide added nutrition to the diet, aid in the prevention of certain diseases, offset the consequences of poor health choices, and reduce or slow down some of the effects of aging on the body.

### FIELD OF THE INVENTION

The present invention is drawn to nutritional herb and fruit beverages. Accordingly, the invention involves the fields of nutritional and health sciences and medicine.

### BACKGROUND OF THE INVENTION

The aging of the population and the increasing importance that consumers attach to health indicates that health promotion related industries will continue to grow; especially considering that many fruits and vegetables contain fewer nutrients today than they did in the past. Additionally, the presence of other vital nutrients in fruits and vegetables, such as antioxidants, fatty acids, tocopherols, flavonoids, and/or sterols, have also diminished over time. Nutritional supplements, now more then ever, are needed to ensure that basic nutritional needs are met.

In spite of some of the trends, there are also many fruits and herbs that contain important antioxidants and other phytonutrients which may provide free radical scavenging protection and improved regeneration effects to the body's immune system, or can be beneficial for other reasons, including increasing vision, combating obesity, preventing skin conditions, and/or protecting against cancer. In view of the forgoing, nutritional formulations and methods which supplement basic nutritional needs and impart positive health benefits continue to be sought.

### SUMMARY OF THE INVENTION

It has been recognized that a drink or drink concentrate that combines the benefits of various fruits with the benefits of nutritional amounts of herbs would provide positive health benefits. Thus, the present invention includes formulations that can provide quick and convenient sources of nutrition. In one aspect, a drink or drink concentrate can comprise longan, a berry, and an herb. The berry can be selected from the group consisting of lycium berry, hawthorne berry, schisandra berry, seabuckthorn berry, and mixtures thereof. The herb can be selected from the group consisting of astragalus, jujube date, coriolus versicolor, rhodiola rosea, and mixtures thereof. The drink or drink concentrate can be formulated as a fruit-based drink or drink concentrate.

In another embodiment, a drink or drink concentrate can comprise apple juice, a secondary fruit juice, and a fruit or herb. The secondary fruit can be selected from the group consisting of pineapple, white grape, pear, and mixtures thereof. The fruit or herb can be selected from the group consisting of euphoria longan, lyceum berry, astragalus, jujube date, gac, cili, seabuckthorn berry, coriolus versicolor, durian, and mixtures thereof. Again, the drink or drink concentrate can be formulated as a fruit-based drink or drink concentrate.

In other embodiments, methods of providing nutritional benefits to a subject can comprise orally administering one of the nutritional fruit-based drinks described above to a subject.

### DETAILED DESCRIPTION OF THE PREFERRED EMBODIMENT(S)

Before particular embodiments of the present invention are disclosed and described, it is to be understood that this invention is not limited to the particular process and materials disclosed herein as such may vary to some degree. It is also to be understood that the terminology used herein is used for the purpose of describing particular embodiments only and is not intended to be limiting.

In describing and claiming the present invention, the following terminology is used.

The singular forms “a,” “an,” and “the” include plural referents unless the context clearly dictates otherwise. Thus, for example, reference to “a juice” includes reference to one or more of such juices.

As used herein, “subject” refers to a mammal that may benefit from the fruit juices according to aspects of the present invention. Most often, the subject will be a human.

As used herein, “extract” when used in connection with a plant, tree, herb, fungus, etc., refers to material which has been removed from the source, or a portion thereof, including the flower, fruit, seed, peel, leaf, root, bark, stem, etc. As will be recognized by those of ordinary skill in the art, extracts may be either crude or refined to a selected degree in order to isolate specified materials or active agents. A number of extraction processes that can be employed to produce the compositions of various types will be recognized by those skilled in the art, such as dehydration, lyophilization, CO₂ extraction, fractionation, solvent based extraction, combinations thereof, etc.

“Antioxidant” refers to a chemical compound, an enzyme or other organic molecule which prevents free radicals from causing oxidation of molecules in the body. Susceptible molecules include without limitation, such vital entities as DNA, RNA, lipids (fats), and proteins. The antioxidant, by reacting with the oxidant, protects these important molecules from being damaged. Examples of antioxidants include without limitation, vitamins A, C, E, carotenoids, polyphenols, and certain minerals.

As used herein, “concentrate” refers to a concentrated form of a foodstuff which is formed by any conventional means, usually by the removal of water.

As used herein, the term “fruit-based” does not require that the major component in a composition be a fruit juice, but rather, that fruit juice(s) is in an amount that is greater than any other component other than water. For example, a coffee that includes a fruit component would not be considered “fruit-based.”

As used herein, a plurality of items, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, amounts, and other numerical data may be expressed or presented herein in a range format. It is to be understood that such a range format is used merely for convenience and brevity and thus should be interpreted flexibly to include not only the numerical values explicitly recited as the limits of the range, but also to include all the individual numerical values or sub-ranges encompassed within that range as if each numerical value and sub-range is explicitly recited. As an illustration, a numerical range of “about 1 to about 5” should be interpreted to include not only the explicitly recited values of about 1 to about 5, but also include individual values and sub-ranges within the indicated range. Thus, included in this numerical range are individual values such as 2, 3, and 4 and sub-ranges such as from 1-3, from 2-4, and from 3-5, etc. This same principle applies to ranges reciting only one numerical value. Furthermore, such an interpretation should apply regardless of the breadth of the range or the characteristics being described.

The nutritional value of many foods has declined in recent years. Even those foods traditionally thought to be rich in important vitamins, minerals, and other nutrients, such as fruit and vegetables, have recently been discovered to be something less nutritional than in the recent past. It has been discovered that various unique formulations of herb and fruit juices can be beneficial for multiple purposes. These unique formulations can supplement the most basic nutritional needs, even for the health conscious individual. Furthermore, many fruits and herbs contain compounds that can provide added nutrition, particularly given the poor nutritional habits of many individuals. Additionally, combinations of these fruits and herbs can be used to help prevent disease, counterbalance the consequences of poor health choices, and reduce or slow down some of the effects of aging on the body, to name a few benefits. Thus, compositions in the form of liquid drinks or concentrates including certain fruits and herbs may provide important health enhancing benefits in a quick and convenient form.

In accordance with this, in one aspect, a drink or drink concentrate can comprise longan, a berry, and an herb. The berry can be selected from the group consisting of lycium berry, hawthorne berry, schisandra berry, seabuckthorn berry, and mixtures thereof. For example, the berry can be one, two, three, or all of these or even other berries. The herb can be selected from the group consisting of astragalus, jujube date, coriolus versicolor, rhodiola rosea, and mixtures thereof. For example, the herb can be one, two, three, or even all of these or other herbs. The drink or drink concentrate can be formulated as a fruit-based drink or drink concentrate.

In this embodiment, a secondary fruit juice can also be present, such as one or more selected from the group consisting of pineapple, apple, white grape, pear, and mixtures thereof. Additionally, a secondary herb or additive can also or alternatively be present, such as cili, gac, ginger, tangerine peel, mangosteen, durian, litchi, citric acid anhydrous, xanthan gum, and mixtures thereof. Vitamin ingredients can also be present such as water-soluble vitamins. In another specific embodiment, the longan can be euphoria longan.

In accordance with these more specific embodiments, it is generally contemplated that the fruit drinks or concentrates described herein can include one, two, three, or more different fruit juices and herbs as described herein; one, two, three, or more berries as described herein; one, two, three, or more herbs as described herein, etc. Such juices and herbs can provide natural sources of fiber, vitamins, minerals, and various other nutrients and compounds that can provide various health benefits.

In addition to many of the fruits listed and described above, other juices can be added for taste, cost considerations, nutritional benefits, fillers, etc., in accordance with some embodiments of the present invention. For example, fruits that can be added for this purpose include apple, cloudy apple, pear, white grape, tangerine, pineapple, and mixtures and concentrates thereof. In accordance with this, in another embodiment, a drink or drink concentrate can comprise apple juice, a secondary fruit juice, and a fruit or herb. The secondary fruit can be selected from the group consisting of pineapple, white grape, pear, and mixtures thereof. For example, the secondary fruit can be one, two, or all three of these fruit juices. The fruit or herb can be selected from the group consisting of euphoria longan, lyceum berry, astragalus, jujube date, gac, cili, seabuckthorn berry, coriolus versicolor, durian, and mixtures thereof. Again, the drink or drink concentrate can be formulated as a fruit-based drink or drink concentrate. In one particular embodiment, the apple juice can be cloudy apple juice.

In the above-described embodiments, fruit juices or concentrates for inclusion in the fruit drinks or concentrates of the present invention can be prepared by any means known to one of ordinary skill in the art. For example, the fruits may be juiced, blended, pureed, crushed, squeezed, cooked, etc. Additionally, fruit juices may be included as extracts, powders, or concentrates, either as-is or in a reconstituted form.

Though any functional amount of fruits, berries, herb, etc., can be present in the liquid or concentrate compositions of the present invention, typically, the total amount of components other than water can be from about 0.5 wt % to 100 wt %.

In addition to the fruit juices and berries described herein, other herbal and botanical ingredients and extracts may be incorporated into the fruit drinks of the present invention that may impart positive health benefits, many of which are set forth above. Generally, herbal and botanical ingredients and extracts are made from all kinds of herb and botanic sources and formulated based on a desired therapeutic function. Various therapeutic functions may include, for example, anti-flu, bone/joint, brain function, cardiovascular, circulatory, diet, depression, digestion, energy, eye vision, general health, immune system, liver, men's health respiratory, rest, urinary tract, women's health, etc. The amount of herbal and botanical ingredients included in the fruit drinks of the present invention may vary depending on the ingredient and the intended benefits to be derived from the fruit drink. In one aspect, however, the amount of the herbal ingredient may range from about 0.1 wt % to about 50 wt %. Examples of other herbs not previously mentioned that can be included are rambulan, longkong, carambola, quanara, acai berry, qing mei, quinoa, and mixtures thereof.

Vitamin ingredients can also be included in the fruit drinks according to various aspects of the present invention to impart additional nutritional value thereto. Any vitamin known to one of ordinary skill in the art can be included, depending on the desired nutritional effects of the resulting fruit drink. In one aspect, the vitamin ingredient can include a water soluble vitamin. Non-limiting examples of water soluble vitamins can include Vitamin B₁, B₂, B₃, B₅, B₆, B₁₂, B₁₃, B₁₅, B₁₇, biotin, Vitamin C, Vitamin P, choline, para-aminobenzoic acid (PABA), folic acid, inositol, and mixtures thereof. The amount of vitamin(s) present can be related to the recommended daily allowance, though any safe concentration can be present.

In addition to the ingredients described above, it is noted that any other ingredient can be added that is useful for formulating the compositions of the present invention. Such ingredients include various preservative, sweeteners, thickeners, fillers, and the like, which can be used for various purposes including modification of the taste, texture and shelf-life of fruit drinks.

In other embodiments, methods of providing nutritional benefits to a subject can comprise orally administering a nutritional fruit-based drink described above to a subject.

### EXAMPLES

It is to be understood that while the invention has been described in conjunction with certain preferred specific embodiments thereof, that which follows is intended to illustrate and not limit the scope of the invention. Other aspects of the invention will be apparent to those skilled in the art to which the invention pertains.

### Example 1

A fruit-based liquid is prepared using the following ingredients:

| Ingredients | Concentration (%, w/w) |
|---|---|
| Cloudy apple juice | 10–20% |
| Pear puree | 10–20% |
| White grape | 5–10% |
| Pineapple | 1–5% |
| Frozen longan | .3–1% |
| Other¹ | balance |

¹In Examples 1, “Other” may include water, other juices, fillers, preservatives, sweeteners, amino acids, phytonutrients, herbs, vitamins, and/or other additional ingredients. etc.

### Example 2

An herb blend is prepared using the following ingredients:

| Ingredients of herb/fruit blend | Concentration (% w/w) |
|---|---|
| Astragalus | 10–20% |
| Euphoria longan | 10–20% |
| Lycium berry | 10–20% |
| Jujube date | 5–15% |
| Cili | 2–10% |
| Coriolus versicolor | 2–10% |
| Gac | 2–10% |
| Ginger | 2–10% |
| Hawthorn berry | 2–10% |
| Rhodiola rosea | 2–10% |
| Schisandra berry | 2–10% |
| Seabuckthorn berry | 2–10% |
| Tangerine peel | 2–10% |
| Mangosteen | 1–8% |
| Durian | 1–8% |
| Litchi | .5–5% |

### Example 3

A ready-to-drink fruit-based beverage is prepared by mixing about 99 wt % of the fruit-based liquid of Example 1 with about 1 wt % of the herb blend of Example 2.

### Example 4

A ready-to-drink fruit-based beverage is prepared using the following ingredients:

| Ingredients | Concentration (% w/w) |
|---|---|
| Euphoria longan | 0.1–0.5% |
| Lycium berry | 0.1–0.5% |
| Hawthorn berry | 0.02–0.2% |
| Schisandra berry | 0.02–0.2% |
| Seabuckthorn berry | 0.02–0.2% |
| Astragalus | 0.1–0.5% |
| Jujube date | 0.05–0.5% |
| Coriolus versicolor | 0.02–0.2% |
| Rhodiola rosea | 0.02–0.2% |
| Other² | balance |

²In Examples 4, “Other” may include water, juices, fillers, preservatives, sweeteners, amino acids, phytonutrients, herbs, vitamins, and/or other additional ingredients, etc.

### Example 5

A ready-to-drink fruit-based beverage is prepared using the following ingredients:

| Ingredients | Concentration (% w/w) |
|---|---|
| Cloudy apple juice | 10–20% |
| Pear puree | 10–20% |
| White grape | 5–10% |
| Pineapple | 1–5% |
| Frozen longan | .3–1% |
| NatTropical berry flavor | .2–2% |
| Citrus acid anhydrous | .1–2% |
| Exberry Shade Bordea | .1–2% |
| Xanthan gum | .05–1% |
| Cyanocobalamin | .003–.05% |
| Pyridoxine HCL | .0006–.05% |
| Astragalus | .05–1% |
| Lycium berry | .05–1% |
| Jujube date | .05–1% |
| Cili | .05–1% |
| Coriolus versicolor | .05–1% |
| Gac | .05–1% |
| Ginger | .05–1% |
| Hawthorn berry | .05–1% |
| Rhodiola rosea | .05–1% |
| Schisandra berry | .05–1% |
| Seabuckthorn berry | .05–1% |
| Tangerine peel | .05–1% |
| Mangosteen | .05–1% |
| Durian | .05–1% |
| Litchi | .05–1% |
| Euphoria longan | .05–1% |
| Other³ | balance |

³In Examples 5, “Other” may include water, other juices, fillers, preservatives, sweeteners, amino acids, phytonutrients, herbs, vitamins, and/or other additional ingredients, etc.

### Example 6

A ready-to-drink fruit-based beverage is prepared using the following ingredients:

| Ingredients | Concentration (% w/w) |
|---|---|
| Apple juice | 10–20% |
| Pineapple | 10–20% |
| White grape | 5–15% |
| Pear | 5–15% |
| Euphoria longan | .01–2% |
| Lyceum berry | .01–2% |
| Astragalus | .01–2% |
| Jujube date | .01–2% |
| Gac | .01–2% |
| Cili | .01–2% |
| Seabuckthorn berry | .01–2% |
| Coriolus versicolor | .01–2% |
| Durian | .01–2% |
| Other⁴ | balance |

⁴In Examples 6, “Other” may include water, other juices, fillers, preservatives, sweeteners, amino acids, phytonutrients, herbs, vitamins, and/or other additional ingredients, etc.

### Example 7

The ready-to-drink fruit-based beverages described in Examples 1-6 are concentrated or dehydrated by conventional methods to form a fruit drink concentrate or powder. Alternatively, individual fruit juice components can be concentrated individually, and the concentrate can be included in a fruit juice mixture, thus, altering the wt % set forth in the examples because of the respective concentrated forms.

It is to be understood that the above-described arrangements are only illustrative of the application of the principles of the present invention. Numerous modifications and alternative arrangements may be devised by those skilled in the art without departing from the spirit and scope of the present invention. Thus, while the present invention has been fully described above with particularity and detail in connection with what is presently deemed to be the most practical and preferred embodiments of the invention, it will be apparent to those of ordinary skill in the art that numerous modifications, including, but not limited to, variations in materials, form, function, and use may be made without departing from the principles and concepts set forth herein.

What is claimed is:

1. A drink or drink concentrate, comprising:
longan;
a berry selected from the group consisting of lycium berry, hawthorne berry schisandra berry, seabuckthorn berry, and mixtures thereof; and
an herb selected from the group consisting of astragalus, jujube date, coriolus versicolor, rhodiola rosea, and mixtures thereof;
said drink or drink concentrate formulated as a fruit-based drink or drink concentrate.

2. The drink or drink concentrate of claim 1, further comprising a fruit juice selected from the group consisting of pineapple, apple, cloudy apple, white grape, pear, and mixtures thereof.

3. The drink or drink concentrate of claim 1, wherein the berry is lyceum berry.

4. The drink or drink concentrate of claim 1, wherein the berry is hawthorne berry.

5. The drink or drink concentrate of claim 1, wherein the berry is schisandra berry.

6. The drink or drink concentrate of claim 1, wherein the berry is seabuckthorn berry.

7. The drink or drink concentrate of claim 1, wherein the herb is astragalus.

8. The drink or drink concentrate of claim 1, wherein the herb is jujube date.

9. The drink or drink concentrate of claim 1, wherein the herb is coriolus versicolor.

10. The drink or drink concentrate of claim 1, wherein the herb is rhodiola rosea.

11. The drink or drink concentrate of claim 1, wherein the berry includes at least two berries selected from the group consisting of lycium berry, hawthorne berry, schisandra berry, and seabuckthorn berry.

12. The drink or drink concentrate of claim 1, wherein the berry includes at least three berries selected from the group consisting of lycium berry, hawthorne berry, schisandra berry, and seabuckthorn berry.

13. The drink or drink concentrate of claim 1, wherein the berry includes lycium berry, hawthorne berry, schisandra berry, and seabuckthorn berry.

14. The drink or drink concentrate of claim 1, wherein the herb includes at least two herbs selected from the group consisting of astragalus, jujube date, coriolus versicolor, and rhodiola rosea.

15. The drink or drink concentrate of claim 1, wherein the herb includes at least three herbs selected from the group consisting of astragalus, jujube date, coriolus versicolor, and rhodiola rosea.

16. The drink or drink concentrate of claim 1, further comprising a secondary herb selected from the group consisting of gac, cili, durian, mangosteen, ginger, tangerine peel, litchi, citric acid anhydrous, rambulan, longkong, carambola, quanara, acai berry, qing mei, quinoa, xanthan gum, and mixtures thereof.

17. The drink or drink concentrate of claim 1, further comprising at least one vitamin ingredient.

18. The drink or drink concentrate of claim 17, wherein the at least one vitamin ingredient is a water-soluble vitamin.

19. The drink or drink concentrate of claim 18, wherein the at least one water-soluble vitamin includes a member selected from vitamin B₁, vitamin B₂, vitamin B₃, vitamin B₅, vitamin B₆, vitamin B₁₂, vitamin B₁₃, vitamin B₁₅, vitamin B₁₇, biotin, vitamin C, vitamin P, choline, para-aminobenzoic acid (PABA), folic acid, inositol, and mixtures thereof.

20. The drink or drink concentrate of claim 1, wherein the longan is euphoria longan.

21. The drink or drink concentrate of claim 1, wherein the longan is frozen longan.

22. The drink or drink concentrate of claim 1, further comprising at least one herb, mineral, amino acid ingredient, antioxidant, or phytonutrient.

23. The drink or drink concentrate of claim 1, further comprising a fruit or berry juice selected from the group consisting of pineapple, orange, lemon, grapefruit, grape, cranberry, raspberry, blackberry, banana, strawberry, peach, blueberry, cherry, and mixtures thereof.

24. A drink or drink concentrate, comprising:
apple juice;
a secondary fruit juice selected from the group consisting of pineapple, white grape, pear, and mixtures thereof;
a fruit or herb selected from the group consisting of euphoria longan, lyceum berry, astragalus, jujube date, gac, cili, seabuckthorn berry, coriolus versicolor, durian, and mixtures thereof;
said drink or drink concentrate formulated as a fruit-based drink or drink concentrate.

25. The drink or drink concentrate of claim 24, wherein the secondary fruit juice is white grape.

26. The drink or drink concentrate of claim 24, wherein the secondary fruit juice is pineapple.

27. The drink or drink concentrate of claim 24, wherein the secondary fruit juice includes at least two juices selected from the group consisting of pineapple, white grape, and pear.

28. The drink or drink concentrate of claim 24, wherein the fruit or herb is astragalus.

29. The drink or drink concentrate of claim 24, wherein the fruit or herb is euphoria longan.

30. The drink or drink concentrate of claim 24, wherein the fruit or herb includes at least two fruits or herbs selected from the group consisting of euphoria longan, lyceum berry, astragalus, jujube date, gac, cili, seabuckthorn berry, coriolus versicolor, and durian.

31. The drink or drink concentrate of claim 24, wherein the fruit or herb includes at least three fruits or herbs selected from the group consisting of euphoria longan, lyceum berry, astragalus, jujube date, gac, cili, seabuckthorn berry, coriolus versicolor, and durian.

32. The drink or drink concentrate of claim 24, wherein the fruit or herb includes at least four fruits or herbs selected from the group consisting of euphoria longan, lyceum berry, astragalus, jujube date, gac, cili, seabuckthorn berry, coriolus versicolor, and durian.

33. The drink or drink concentrate of claim 24, wherein the apple juice is cloudy apple juice.

34. The drink or drink concentrate of claim 24, further comprising at least one vitamin ingredient selected from vitamin B₁, vitamin B₂, vitamin B₃, vitamin B₅, vitamin B₆, vitamin B₁₂, vitamin B₁₃, vitamin B₁₅, vitamin B₁₇, biotin, vitamin C, vitamin P, choline, para-aminobenzoic acid (PABA), folic acid, inositol, and mixtures thereof.

35. A method of providing nutritional benefits to a subject, comprising orally administering a nutritional fruit-based drink to a subject, said fruit-based drink comprising:
longan;
a berry selected from the group consisting of lycium berry, hawthorne berry schisandra berry, seabuckthorn berry, and mixtures thereof; and
an herb selected from the group consisting of astragalus, jujube date, coriolus versicolor, rhodiola rosea, and mixtures thereof.

36. The method of claim 35, further comprising cloudy apple juice.

37. The method of claim 35, further comprising a fruit juice selected from the group consisting of pineapple, white grape, pear, and mixtures thereof.

38. The method of claim 35, wherein the longan includes euphoria longan.

39. The method of claim 35, wherein the longan includes frozen longan.

40. The method of claim 35, further comprising a fruit or herb selected from the group consisting of gac, cili, durian, mangosteen, ginger, tangerine peel, litchi, citric acid anhydrous, rambulan, longkong, carambola, quanara, acai berry, qing mei, quinoa, xanthan gum, and mixtures thereof.

41. The method of claim 35, further comprising at least one herb, vitamin, mineral, amino acid ingredient, antioxidant, or phytonutrient.

42. The method of claim 35, further comprising a fruit juice selected from the group consisting of pineapple, orange, lemon, grapefruit, grape, cranberry, raspberry, blackberry, banana, apple, strawberry, peach, blueberry, cherry, and mixtures thereof.

43. A method of providing nutritional benefits to a subject, comprising orally administering a nutritional fruit-based drink to a subject, said fruit-based drink comprising:
apple juice;
a secondary fruit juice selected from the group consisting of pineapple, white grape, pear, and mixtures thereof;
a fruit or herb selected from the group consisting of euphoria longan, lyceum berry, astragalus, jujube date, gac, cili, seabuckthorn berry, coriolus versicolor, durian, and mixtures thereof;
said drink or drink concentrate formulated as a fruit-based drink or drink concentrate.

44. The method of claim 43, wherein the apple juice is cloudy apple juice.

45. The method of claim 43, further comprising at least one vitamin ingredient selected from vitamin B₁, vitamin B₂, vitamin B₃, vitamin B₅, vitamin B₆, vitamin B₁₂, vitamin B₁₃, vitamin B₁₅, vitamin B₁₇, biotin, vitamin C, vitamin P, choline, para-aminobenzoic acid (PABA), folic acid, inositol, and mixtures thereof.
